(19) United States
(12) Patent Application Publication
(10) Pub. No.: US 2012/0286942 A1
(43) Pub. Date: Nov. 15, 2012

(54) FREQUENCY-ADJUSTABLE HIGH-POWER MOUSE EXPELLER

(76) Inventor: CHIH-HSIEN WU, Taipei City (TW)

(21) Appl. No.: 13/557,234

(22) Filed: Jul. 25, 2012

Related U.S. Application Data
(63) Continuation-in-part of application No. 12/698,146, filed on Feb. 2, 2010.

(51) Int. Cl. A01M 29/00

(52) U.S. Cl. 340/384.2

(57) ABSTRACT

The mouse expeller contains a casing member, a control circuit inside the casing member, and at least a sounding device also inside the casing member and connected to the control circuit. The control circuit contains a voltage regulator IC, audio-frequency oscillator ICs, variable resistors, capacitors, transistors, resistors, and a light emitting diode (LED), a switch, and a power connector. The power connector is connected to a power adaptor. Adjusting the variable resistors is able to alter the frequencies of the audio-frequency oscillator ICs. The sounding device contains a tubular body functioning as a closed resonant chamber so as to boost the sound power to cover a large area.

### CROSS-REFERENCE TO RELATED APPLICATION

This application is a continuation-in-part of the co-pending patent application Ser. No. 12/698,146, owned by the same applicant.

### TECHNICAL FIELD OF THE INVENTION

The present invention generally relates to mouse expellers, and especially relates to a mouse expeller that is frequency-adjustable, boost-type, audio-frequency or ultrasonic mouse expeller.

### DESCRIPTION OF THE PRIOR ART

A conventional ultrasonic mouse expeller uses an oscillation circuit to generate a sound wave of an ultrasonic frequency so as to make mice in the vicinity to feel uncomfortable and escape. This type of conventional mouse expeller employs a single-frequency ultrasonic transducer which is capable of producing high-power sound wave. Yet, only a single sound wave pattern of the same frequency is generated. After a period of usage, mice would become used to the sound wave pattern and the expelling effect is diminished. There are also some mouse expellers using some microcontroller to produce sound waves of multiple, randomly picked frequencies or by auto sweep. The ultrasonic transducer or ceramic buzzer thereby could deliver continuously changing sound wave patterns. However, a common drawback of this type of mouse expellers is that the sound power is too limited to cover a large area.

### SUMMARY OF THE INVENTION

Therefore, a major purpose of the present invention is to provide a frequency-adjustable means to the mouse expeller so that the expelling effect is not diminished when mice are getting used to a fixed frequency.

Another major purpose of the present invention is to provide a resonant means to the mouse expeller so that high-power sound wave can be produced to cover a large area.

To achieve the above purposes, the mouse expeller contains a casing member having an open back side sealed by a cover and at least an opening on a front side, a control circuit inside the casing member, and at least a sounding device also inside the casing member and connected to the control circuit. The control circuit contains a voltage regulator IC, a first audio-frequency oscillator IC, a second audio-frequency oscillator IC, variable resistors, capacitors, transistors, resistors, and a light emitting diode (LED), a switch, and a power connector. The power connector is connected to the voltage regulator IC, the first audio-frequency oscillator IC, a number of variable resistors, capacitors, transistors, resistors, and the light emitting diode. The second audio-frequency oscillator IC is connected to a variable resistor, the switch, and at least a transistor. The transistor is connected to the sounding device. The variable resistor, power connector, and switch are exposed from the cover. The power connector is connected to a power adaptor. Adjusting the variable resistor is able to alter the frequency of the second audio-frequency oscillator IC.

The sounding device contains a speaker, a back cover, a front cover, and a tubular body. The front and back covers are joined by bolts with the speaker and the tubular body sandwiched in between. The tubular body functions as a closed resonant chamber so as to boost the sound power.

The sounding device is preferably a boost-type ultrasonic sounding device.

The tubular body is preferably made of a metallic or plastic material.

Compared to conventional mouse expellers, the present invention has the following advantages.

Firstly, the resonant effect provided by the closed tubular body achieves high sound power so that the expelling effect is effectively enhanced.

Secondly, the tubular body can be made of various materials yet the same high sound power can be produced.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a mouse expeller according to a first embodiment of the present invention.

FIG. 2 is a perspective diagram showing the mouse expeller of FIG. 1 after assembly.

FIG. 3 is another perspective diagram showing the back of the mouse expeller of FIG. 1.

FIG. 4 is a perspective diagram showing a mouse expeller according to a second embodiment of the present invention.

FIG. 5 is a circuit diagram showing a control circuit adopted by the mouse expeller according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

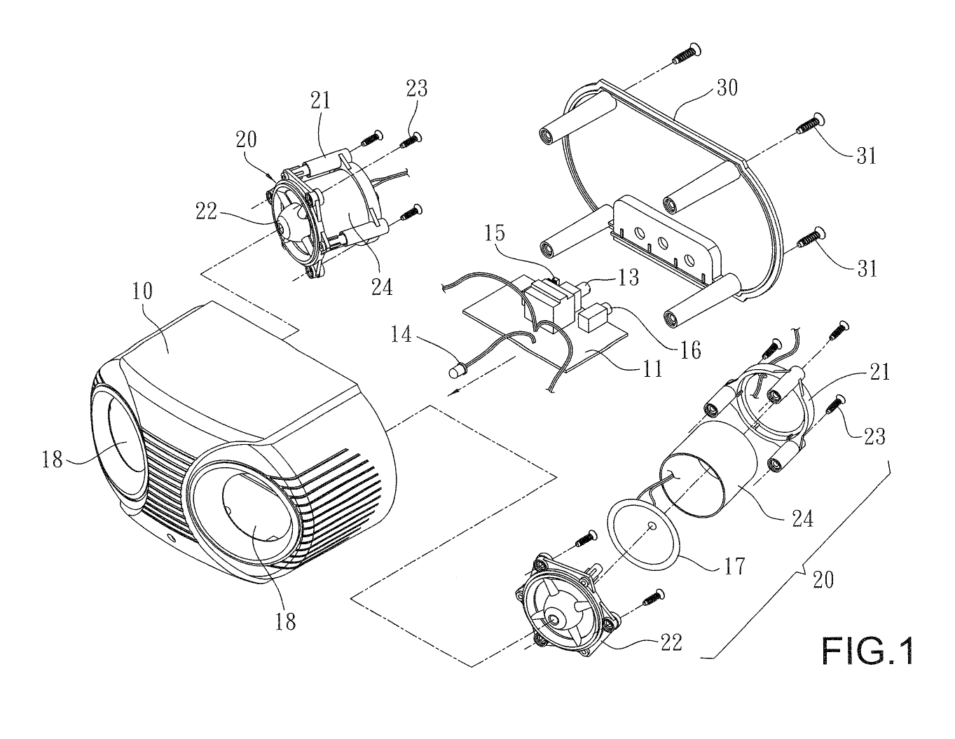

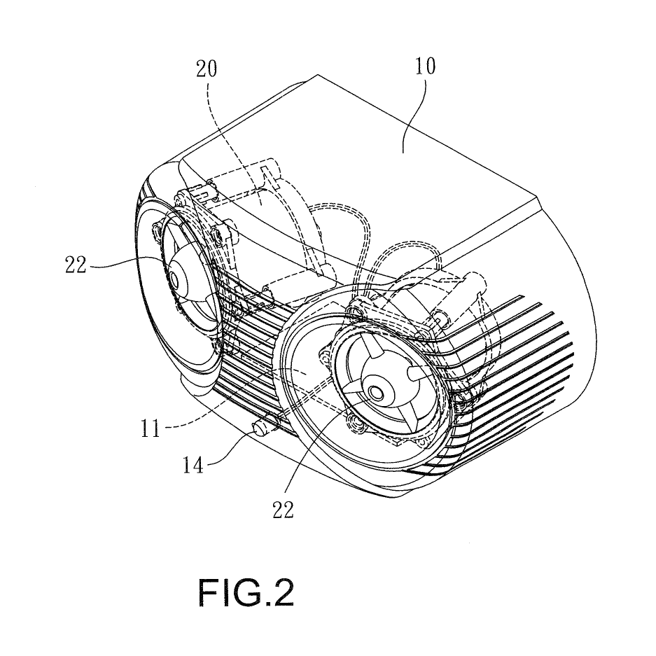

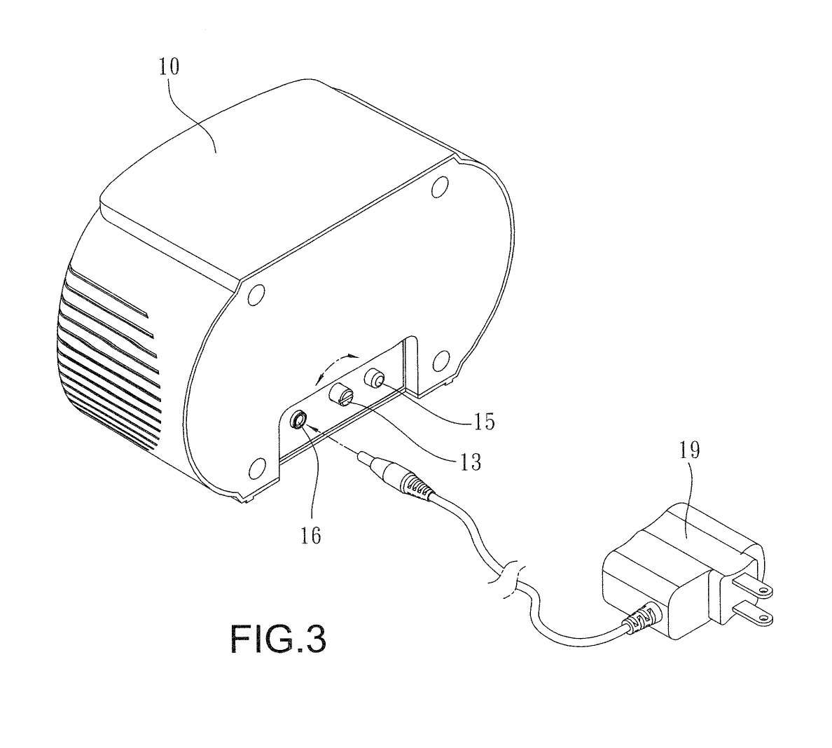

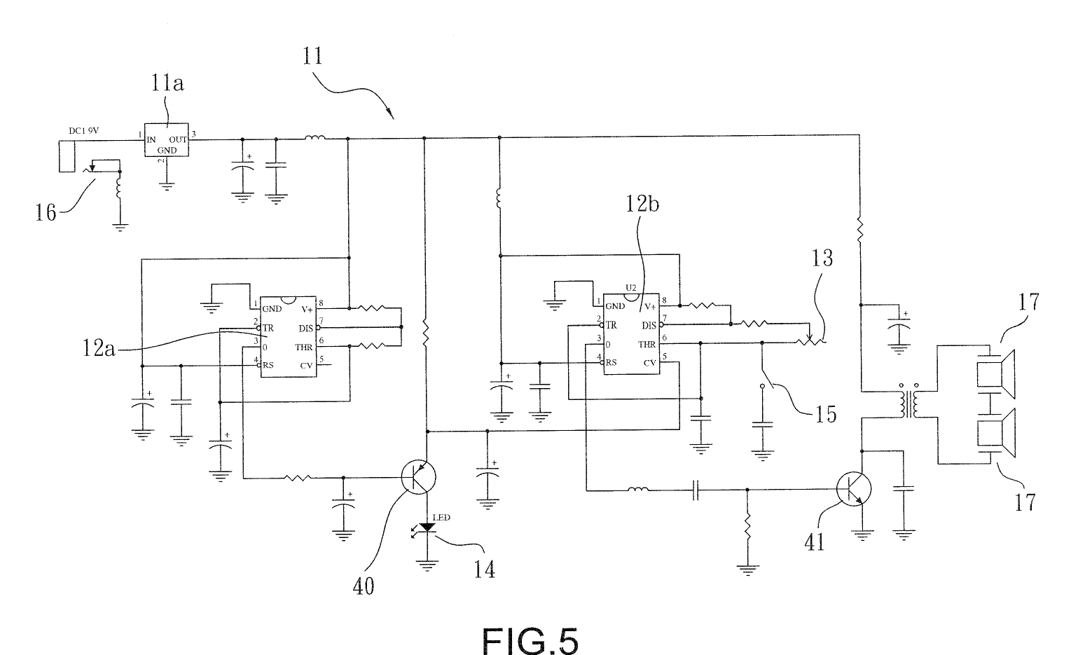

As shown in FIGS. 1, 2, and 5, a frequency-adjustable high-power mouse expeller according to a first embodiment of the present invention contains a casing member 10 and a control circuit 11 housed inside the casing member 10. The casing member 10 has an open back side sealed by a cover 30 and fixed by a number of bolts 31. The control circuit 11, as shown in FIG. 5, contains a voltage regulator IC 11a, a first audio-frequency oscillator IC 12a and a second audio-frequency oscillator IC 12b. A power connector 16 is connected to the voltage regulator IC 11a, a number of capacitors, transistors 40, resistors, and a light emitting diode (LED) 14. An output end of the first audio-frequency oscillator IC 12a is connected to a transistor 40 whose collector and emitter are connected to the LED 14 and a resistor, respectively. The emitter is also connected to the second audio-frequency oscillator IC 12b, which in turn is connected to a variable resistor 13 and a switch 15. A terminal of the second audio-frequency oscillator IC 12b is connected to two transistors 41 configured in parallel, which in turn are connected to two sounding devices 20. Each sounding device 20 can be a boost-type audio-frequency sounding device, or a boost-type ultrasonic sounding device. As shown in FIG. 1, each sounding device 20 contains a speaker 17, a back cover 21, a front cover 22, and a tubular body 24. The front cover 22 is configured in front of the sounding device 20 whereas the back cover 21 is configured to the back of the sounding device 20. The front and back covers 22 and 21 are joined by a number of bolts 23 with the speaker 17 and the tubular body 24 sandwiched in between. The LED 14 is exposed from a front surface of the front cover 22 which in turn is exposed from an opening 18 on a front side of the casing member 10. The variable resistor 13, the switch 15, and the power connector 16 are exposed from a back surface of the back cover 21, as shown in FIG. 3. The speaker 17 seals a front opening of the tubular body 24 so that the tubular body 24 becomes a closed resonant chamber. The tubular body 24 is preferably made of aluminum. Other material such as plastic or copper also suffices.

As shown in FIG. 3, the power connector 16 is connected to a power adaptor 19 which is plugged into a wall socket so as to draw electricity to drive the control circuit 11. The variable resistor 13 provides manual adjustment to the audio-frequency oscillator ICs 12a or 12b to produce signals of desired frequencies. The signals are then delivered to the speakers 17 of the sounding devices 20 to generate audio or ultrasonic sound to expel mice. The sound power is boosted by the resonant chambers formed by the tubular bodies 24 so as to enhance the expelling effect.

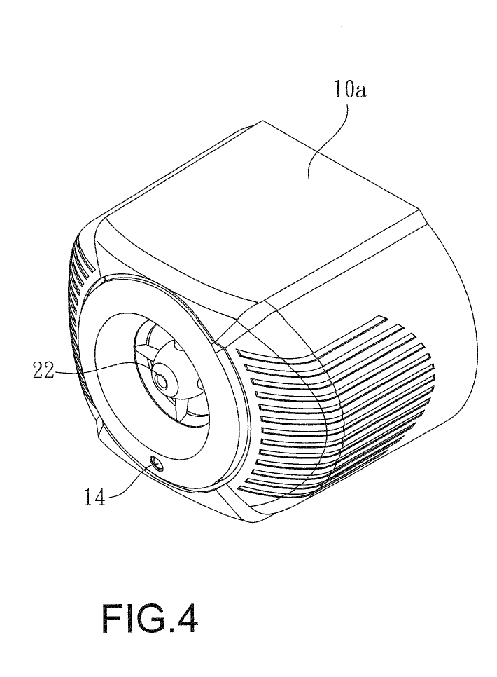

FIG. 4 depicts a mouse expeller according to a second embodiment of the present invention. As illustrated, the mouse expeller has a casing member 10a and a same control circuit (not shown) as the previous embodiment housed inside. However, the control circuit contains a single audio-frequency oscillator IC and a single sounding device 20 which can be a boost-type audio-frequency sounding device, or a boost-type ultrasonic sounding device. A LED 14 is also exposed from a front side of the casing member 10a. The present embodiment is appropriate for expelling mice in a smaller space.

Compared to conventional mouse expellers, the present invention has the following advantages.

First of all, the sound frequency could be manually and easily adjusted by the variable resistor at any time, so that the expelling effect is not diminished when the mice are used to a fixed frequency.

Secondly, the high sound power of the present invention's mouse expeller could make a user uncomfortable under a particular frequency. The manual frequency variation of the present invention can obviate this issue.

Thirdly, the resonant effect provided by the closed tubular body achieves high sound power so that the expelling effect is effectively enhanced.

Fourthly, the tubular body can be made of various materials yet the same high sound power can be produced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mouse expeller, comprising:
a casing member having an open back side sealed by a cover and at least two openings on a front side;
a control circuit inside said casing member comprising a voltage regulator IC, a first audio-frequency oscillator IC, a second audio-frequency oscillator IC, a plurality of variable resistors, capacitors, transistors, resistors, and a light emitting diode (LED), a switch, and a power connector, where said power connector is connected to said voltage regulator IC, a plurality of variable resistors, capacitors, transistors, resistors, and said light emitting diode; said second audio-frequency oscillator IC is connected to a variable resistor, said switch, and two transistors; adjusting said variable resistor is able to vary the frequency of said second audio-frequency oscillator IC; said two transistors are connected to at least two sounding devices, respectively; said variable resistor, said power connector, and said switch are exposed from said cover; said power connector is connected to a power adaptor; and
said two sounding devices inside said casing member connected to said control circuit, each comprising a speaker, a back cover, a front cover, and a tubular body, said front cover configured in front of said sounding device, said back cover configured to the back of said sounding device, said front and back covers joined by a plurality of bolts with said speaker and said tubular body sandwiched in between, said tubular body functioning as a closed resonant chamber.

2. The mouse expeller according to claim 1, wherein said tubular body is made of a metallic or plastic material.

3. The mouse expeller according to claim 1, wherein said sounding device is a boost-type ultrasonic sounding device.

4. The mouse expeller according to claim 1, wherein an output end of said first audio-frequency oscillator IC is connected to a transistor whose collector and emitter are connected to said LED and a resistor, respectively; and said emitter is further connected to said second audio-frequency oscillator IC.
